(19) United States
(12) Patent Application Publication
(10) Pub. No.: US 2026/0258726 A1
(43) Pub. Date: Sep. 3, 2026

(54) EXCITED-VIBRATION DISC-CUTTING ROCK-BREAKING DEVICE OF FRONT ECCENTRIC BLOCK

(71) Applicant: Taiyuan University of Science And Technology, Taiyuan City (CN)

(72) Inventors: Wenjun MENG, Taiyuan City (CN); Long QIAN, Taiyuan City (CN); Zhengyu SUN, Taiyuan City (CN); Jintao LIU, Taiyuan City (CN); Zhaolong WANG, Taiyuan City (CN)

(73) Assignee: Taiyuan University Of Science And Technology, Taiyuan City (CN)

(21) Appl. No.: 19/554,751

(22) Filed: Mar. 3, 2026

(30) Foreign Application Priority Data
Mar. 3, 2025 (CN) 202510239201.5

(51) Int. Cl. E21D 9/10; B06B 1/16

(52) U.S. Cl. CPC E21D 9/1046; B06B 1/16; E21D 9/1086; E21D 9/1013; E21D 9/1093

(57) ABSTRACT

Provided is an excited-vibration disc-cutting rock-breaking device of a front eccentric block, belonging to the technical field of hard rock cutting and tunneling. The vibration rock-breaking device includes a cutting component, an eccentric excitation device, a driving component, and a supporting component. A rear part of the supporting component is fixedly connected to a cutting arm of a road-header. The driving component includes a motor, a main shaft, and various connecting devices. The eccentric excitation device and the cutting component are installed at a front end of the main shaft. The cutting component is installed at the front end of the main shaft. The driving device ensures stable rotation of a cutter disc, and also transmits vibration generated by the eccentric excitation device to the cutter disc.

### CROSS-REFERENCE TO RELATED APPLICATION

This patent application claims the benefit and priority of Chinese Patent Application No. 2025102392015, filed with the China National Intellectual Property Administration on March 03, 2025, the disclosure of which is incorporated by reference herein in its entirety as part of the application.

### TECHNICAL FIELD

The present disclosure belongs to the field of hard rock cutting and tunneling, and in particular, relates to an excited-vibration disc-cutting rock-breaking device of a front eccentric block.

### BACKGROUND

With continuous development of society, a scale of underground engineering construction in China continues to expand. However, a hard rock tunneling technology has long been confronted with technical challenges such as a short cutter service life, low cutting efficiency, and a high cutting load. Especially in hard and extremely hard rock stratums with a Protodyakonov hardness coefficient of f>8, these problems are more prominent. Therefore, at present, a drilling and blasting method is still mainly used for hard rock tunneling. However, the drilling and blasting method also has many drawbacks, such as under-excavation or over-excavation, significant disturbance to surrounding rocks, and poor safety, thereby limiting its application under complex geological conditions.

At present, a rock stratum excavation device mainly uses a pick milling rock-breaking method and a Tunnel Boring Machine (TBM) hob rock-breaking method, but these two methods have some shortcomings. In the case of performing pick milling rock-breaking under hard rock conditions, picks are prone to severe wear, resulting in high maintenance costs. In addition, with the increase of power, vibration of a propulsion machine body may be intensified, thereby shortening a service life of device accessories. On the other hand, the TBM hob rock-breaking method drives a hob to squeeze and impact between rock layers through a cutter disc, which requires a large propulsion force. However, in fact, the proportion of energy used to cut and break rocks is relatively low, so that overall cutting efficiency is low.

### SUMMARY

In order to solve the foregoing problems, the present disclosure provides an excited-vibration disc-cutting rock-breaking device of a front eccentric block which breaks rocks by vibration generated by rotation of an eccentric mass block, thereby achieving efficient rock cutting. At the same time, because the cutter disc may generate self-rotation through friction with a rock, wear of the cutter disc is greatly reduced, and a service life of the cutter disc is prolonged.

In order to achieve the foregoing objective, the used technical solution is as follows. An excited-vibration disc-cutting rock-breaking device of a front eccentric block includes a cutting component, an eccentric excitation device, a driving component, and a supporting component. A rear part of the supporting component is fixedly connected to a cutting arm of a road-header. The cutting component is fixed at a front end of the main shaft. The cutting component freely rotates through friction with a rock. The driving component is installed inside the supporting component, and the excitation device is installed at the front end of the main shaft. The driving device provides power for the eccentric excitation device to generate radial vibration, so that a cutter disc stably cuts the rock.

According to the eccentric vibration rock-breaking device in the present disclosure, the driving component in the rock-breaking device is started, and the eccentric excitation device is driven by the main shaft to rotate to generate high-frequency oscillation, so that the cutter disc can perform radial oscillation and rock breaking.

According to the eccentric vibration rock-breaking device in the present disclosure, the main shaft drives the eccentric excitation device to rotate. At the same time, the cutter disc is in contact with and collides with the rock, so that the cutter disc generates self-rotation.

Through the solution, the beneficial effects of the present disclosure are as follows.

The oscillation intensity and frequency of the cutting component are adjusted by the eccentric excitation device. The mass of the eccentric block and the rotating speed of the main shaft are adjusted according to different rocks. A centrifugal force generated when the main shaft drives the eccentric excitation device to rotate causes the cutter disc to vibrate at a high frequency and impact the rocks to generate fatigue cracks. Moreover, a rock-breaking head is driven by the cutting arm to peel off the rocks generating fatigue cracks, thereby reducing a cutting force. A mass and a position of the mass block on the eccentric excitation device are adjusted. A sensor is added to the cutter barrel, and the rotating speed of the main shaft is adjusted according to the actual cutting situation, thereby improving rock cutting efficiency, and expanding the range of types of rocks that can be broken.

When the cutter disc eccentrically vibrates the rock to break the rock, the cutter disc generates self-rotation through friction with a rock. The follow-up movement may reduce wear of the cutter disc and prolong its service life, thereby reducing the cost, and solving the problems of uneven wear and serious wear of the cutter disc when a hard rock is cut.

The device of the present disclosure uses a block disassembly design. When the cutter disc is seriously worn, only the cutter disc needs to be disassembled and replaced, and the cutter barrel, the eccentric excitation device and the like are detachable mechanisms, so that the worn parts are easily replaced.

The above description is only the summary of the technical method of the present disclosure, thereby providing a clearer understanding of the technical method and enabling its implementation based on the content herein. The preferred embodiment of the present disclosure will be described in detail with reference to the drawings.

### BRIEF DESCRIPTION OF THE DRAWINGS

FIG. 1 is a front view of an eccentric vibration rock-breaking device according to the present disclosure;

FIG. 2 is a cross-sectional view of an eccentric vibration rock-breaking device according to the present disclosure;

FIG. 3 is an exploded view of an eccentric vibration rock-breaking device according to the present disclosure;

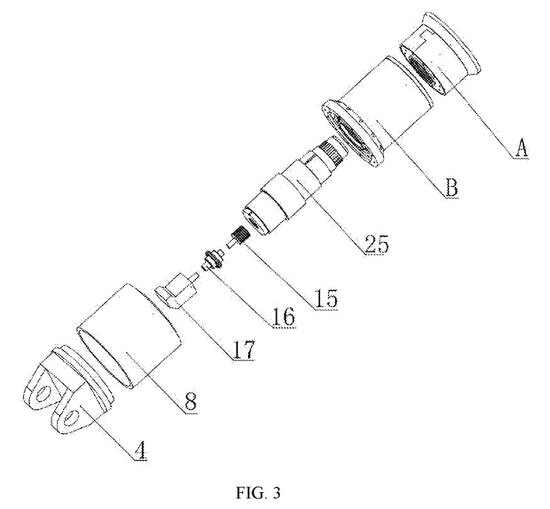

FIG. 4 is an explode view of FIG. 3A; and

FIG. 5 is an explode view of FIG. 3B.

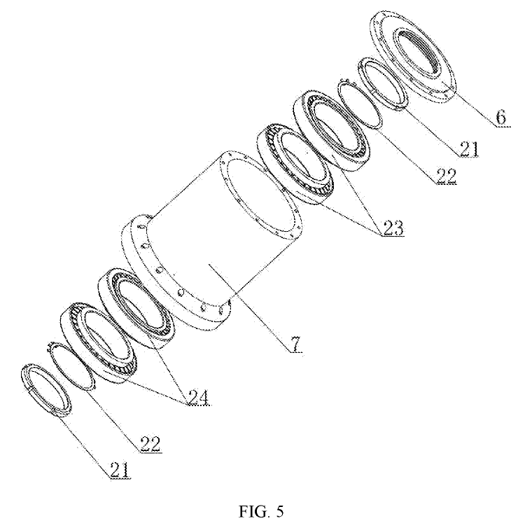

Description of reference numerals:

1. Cutter disc; 2. Split semi-circular cutter barrel; 3. Cutter barrel sealing end cover; 4. Lug; 5. Central axis; 6. Housing sealing end cover; 7. Housing; 8. Wrist; 9. Cutter head sealing end cover; 10. First bearing; 11. Cutter head front-end fixing device; 12. Collar; 13. Eccentric device; 14. Oil-impregnated wick; 15. Connector; 16. Coupling; 17. Motor; 18. Spline; 19. Second bearing; 20. Cutter head rear-end fixing device; 21. Round nut; 22. Stop washer; 23. Third bearing; 24. Fourth bearing; 25. Main shaft.

### DETAILED DESCRIPTION OF THE EMBODIMENTS

Specific embodiments of the present disclosure will be described in more detail with reference to the drawings and examples. The following embodiments are used to explain the present disclosure, but are not intended to limit the scope of the present disclosure.

In the description of the present disclosure, it should be pointed out that when one element is "connected", "coupled" or "linked" to another element, the elements can be considered as being directly connected, coupled or linked, but it should be recognized that there may be intervening elements between the elements. This includes a position relationship between direct connection and indirect connection.

It should be pointed out that when descriptions of "first", "second" and "third" are used to describe each element of the present disclosure, this does not mean any limitation in order, quantity or importance, but is only used to distinguish one element from another.

It should be noted that the use of words indicating orientations such as "up", "down", "left" and "right" is only for the convenience of explaining a relative position relationship, and it is not required that the mentioned devices or elements must have a specific orientation or be constructed and operated in a specific orientation. When the absolute position of the described object changes, the relative position relationship may also change correspondingly.

The embodiment discloses an excited-vibration disc-cutting rock-breaking device of a front eccentric block. A rear part of the supporting component is fixedly connected to a cutting arm of a road-header; the cutting component and the eccentric excitation device are fixedly connected to a front end of the main shaft; the cutting component freely rotates through friction with a rock; the driving component is installed inside the supporting component, the motor is fixedly installed in the lug, and the motor drives the main shaft to drive the eccentric excitation device to rotate; and the eccentric device is fixedly installed at the front end of the main shaft, and rotates when being driven by the main shaft to generate a centrifugal force and generate high-frequency vibration.

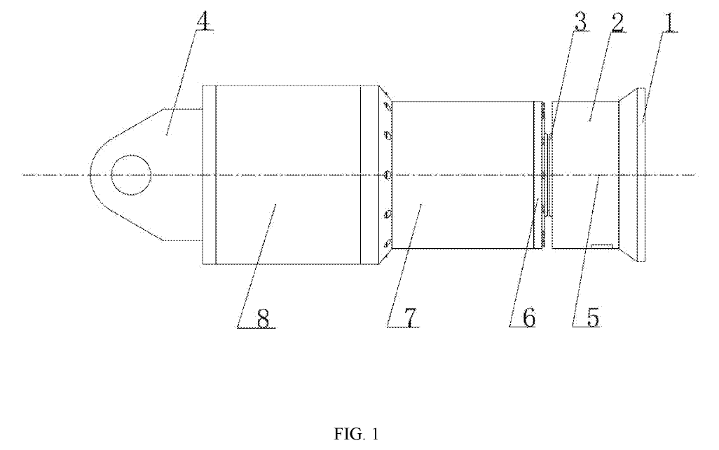

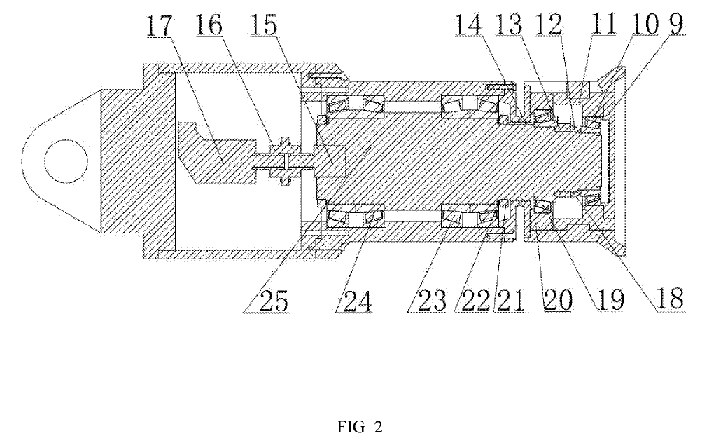

Refer to FIGS. 1 and FIG. 2, which show a structure of a rock-breaking device. Most parts of the device are distributed and installed on the main shaft with the main shaft as the center, in which the wrist and the lug are connected to the cutting arm of the road-header and keep fixed, the main shaft and the eccentric device keep rotating synchronously, and the cutter disc and the cutter barrel rotate freely.

The cutter disc and the cutter barrel are installed at the front end of the main shaft and connected to the main shaft through the first bearing and the second bearing. When cutting rocks, the cutter head may receive a large radial force. Here, two tapered roller bearings are installed in reverse. When an overall size of the cutter barrel is small, by rationally designing the parts of the cutter barrel, a sufficient space is left between the cutter barrels to install the eccentric device, so that the eccentric device does not interfere with the cutter barrel when rotating. At the same time, the size and the position of the eccentric block on the eccentric device may be adjusted more flexibly. The eccentric device installs a spline of the main shaft and is fixed to the collar through a shaft shoulder, thereby reducing the damage to other parts caused by the vibration.

As can be seen from FIG. 2, the rear end of the cutter barrel and the front end of the housing are sealed by non-contact gaps. By installing and adding a lubricating oil device, when the main shaft rotates at a high speed, gravel dust is prevented from entering an elbow, thereby ensuring sealing performance of the cutter barrel and the housing, and reducing friction between the cutter barrel and the housing.

As can be seen from FIG. 2, the third bearing and the fourth bearing are fixed by the round nut and the stop washer. At the same time, because a groove needs to be provided on the shaft during installation of the stop washer, in order to ensure sealing performance of the housing, an oil-impregnated wick is added here.

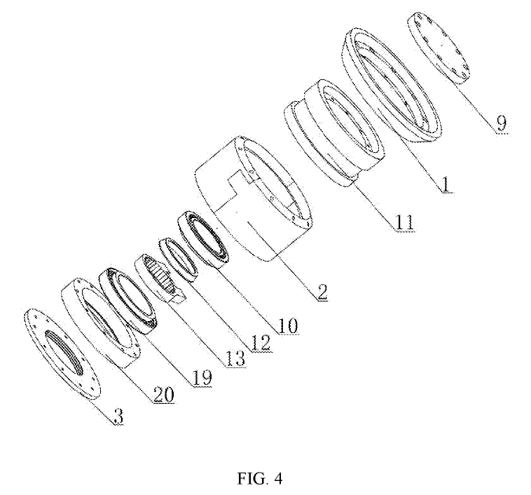

As can be seen from FIGS. 2 and FIG. 4, the main shaft is fixed in the housing through the third bearing and the fourth bearing, and the used bearing is a tapered roller bearing. In order to ensure stability of the device when the device breaks the rock, a pair of tapered roller bearings are used here as the device connecting the main shaft and the housing. The outer ring of the bearing is clamped for pre-tightening, thereby improving rotation accuracy of the bearing, increasing stiffness of the bearing, and reducing vibration of the cutting arm connected to the rock-breaking device.

The eccentric mechanism is arranged in a cavity of the cutter barrel. The eccentric device and the main shaft are fixedly connected by using a spline. The eccentric block is installed in the eccentric device, including but not limited to threaded connection. The eccentric device in FIG. 4 is only for a schematic effect. An actual rhythm may be adjusted according to the size and the type of the eccentric device, and the position is fixed between the first bearing and the second bearing, in which an inner diameter and an outer diameter of the first bearing are smaller than those of the second bearing. A rear section of the main shaft is connected to the motor through a connection form which is not limited to a spline and a coupling. The motor is fixedly connected in the wrist.

Specifically, the eccentric mechanism and the motor of the present disclosure can be replaced with other power devices that can provide power, such as a hydraulic motor, according to specific situations. The eccentric mass block in the present disclosure can be replaced with other devices that can cause oscillation, such as an electromagnetic oscillation device, according to specific situations.

The working principle of rock breaking in the present disclosure is as follows. The main shaft drives the eccentric device to rotate to generate a centrifugal force, which acts on the front end of the main shaft. At this time, the cutter barrel installed at the front end of the main shaft may rotate eccentrically. There is a distance between the center of the cutter head and the rotation center of the main shaft. When the main shaft rotates at a specific speed, high-frequency vibration may be generated. The vibration may cause stress accumulation in the rock, so that internal particles may be relatively displaced, thereby accumulating an elastic potential energy. When the elastic potential energy is accumulated to a specific extent, and the stress reaches a failure limit, the cutter disc scrapes against the rock, thereby destroying tensile strength of the rock, and causing the rock to collapse in a large scale.

It should be noted that the size and the position of the eccentric block, the rotating speed of the main shaft, and the vibration frequency of the cutter head in the eccentric device are different according to different types of rocks to be cut. The size and the position of the eccentric block and the rotating speed of the motor are adjusted according to different types of rocks to be cut, thereby achieving an efficient and accurate rock breaking effect.

To sum up, the rock breaking method provided by the present disclosure may improve cutting efficiency, reduce a cutting force on the cutter disc, expand the applicable range of rocks, reduce wear of the cutter disc, and reduce rock breaking costs.

What has been described above is only a preferred embodiment of the present disclosure, and is not used to limit the present disclosure. It should be pointed out that those skilled in the art can make several modifications and variations without departing from the technical principle of the present disclosure, and these modifications and variations should also be regarded as the scope of protection of the present disclosure.

What is claimed is:

1. An excited-vibration disc-cutting rock-breaking device of a front eccentric block, comprising a cutting component, an eccentric excitation device, a driving component, and a supporting component, wherein a rear part of the supporting component is fixedly connected to a cutting arm of a road-header; the cutting component is fixed at a front end of the main shaft; the cutting component freely rotates through friction with a rock; the driving component is installed inside the supporting component, and the excitation device is installed at the front end of the main shaft; and the driving device provides power for the eccentric excitation device to generate radial vibration, so that a cutter disc stably cuts the rock.

2. The excited-vibration disc-cutting rock-breaking device of the front eccentric block according to claim 1, wherein the cutting component comprises a cutter disc (1), a split semi-circular cutter barrel (2), a cutter head sealing end cover (9), a first bearing (10), a cutter head front-end fixing device (11), a second bearing (19), a cutter head rear-end fixing device (20), and a cutter barrel sealing end cover (3); the cutter disc (1) is detachably installed at a front end of the split semi-circular cutter barrel (2) and is fixed by the cutter head front-end fixing device (11); the first bearing (10) is installed at a front-most end of the main shaft (25) and is fixed by the cutter head sealing end cover (9) and a collar (12), an outer ring of the first bearing is connected to the cutter head front-end fixing device (11); the second bearing (19) is installed at the front end of the main shaft (25) and is fixed by an eccentric device (13) and a shaft shoulder, an outer ring of the second bearing is connected to the cutter head rear-end fixing device (20); the split semi-circular cutter barrel (2) is installed on the cutter head front-end fixing device (11) and the cutter head rear-end fixing device (20), and is sealed by the cutter barrel sealing end cover (3); and the cutting component rotates freely through friction with a rock to ensure that a cutter head and the main shaft (25) rotate around a central axis (5) at different rotating speeds through the first bearing and the second bearing installed on the main shaft (25).

3. The excited-vibration disc-cutting rock-breaking device of the front eccentric block according to claim 2, wherein the eccentric excitation device comprises an eccentric device (13), a collar (12), and a spline (18); a detachable mass block is installed on the eccentric device (13), different mass blocks are replaced according to actual working conditions, and a structure on the eccentric device (13) and an installation method of the mass block are not described in detail here; and the eccentric device (13) is installed at a position of the spline (18) at the front end of the main shaft (25), and is fixed by the collar (12) and the second bearing (19) to ensure that the main shaft (25) drives the eccentric device (13) to rotate around the central axis (5) to generate vibration.

4. The excited-vibration disc-cutting rock-breaking device of the front eccentric block according to claim 2, wherein the split semi-circular cutter barrel (2) and the main shaft (25) are fixedly connected through the first bearing (10), the cutter head front-end fixing device (11), the second bearing (19), and the cutter head rear-end fixing device (20); the split semi-circular cutter barrels (2) are two identical parts, which are installed at an outermost side of the cutter barrel, and the cutter disc (1) is installed on the split semi-circular cutter barrel (2); a space is reserved in the cutter barrel for installing the eccentric excitation device; and through the first bearing (10) and the second bearing (19), the cutting component freely rotates through friction with a rock.

5. The excited-vibration disc-cutting rock-breaking device of the front eccentric block according to claim 3, wherein the eccentric device (13) is installed at the front end of the main shaft (25) through a spline, located between the first bearing (10) and the second bearing (19), and close to the cutter disc (1), and when the main shaft (25) drives the eccentric device (13) to rotate, vibration generated by rotation of the eccentric device (13) is effectively transmitted to the cutter disc (1), and rock cutting efficiency is improved.

6. The excited-vibration disc-cutting rock-breaking device of the front eccentric block according to claim 1, wherein the driving component comprises the main shaft (25), a connector (15), a coupling (16), and a motor (17); and in the driving component, the motor (17) is connected to the main shaft through the coupling (16) and the connector (15), and the motor (17) is fixedly installed on a wrist to provide power to rotate the main shaft (25).

7. The excited-vibration disc-cutting rock-breaking device of the front eccentric block according to claim 1, wherein the supporting component comprises a housing sealing end cover (6), an oil-impregnated wick (14), a housing (7), a wrist (8), a lug (4), a third bearing (23), a fourth bearing (24), a round nut (21), and a stop washer (22), the lug (4) is connected to a rear-end cutting arm, the housing (7) is installed outside the third bearing (23) and the fourth bearing (24) and connected to the wrist (8), the third bearing (23) and the fourth bearing (24) are both fixed by the round nut (21) and the stop washer (22), the housing sealing end cover (6) is installed at a front end of the housing (7), a part in which the housing sealing end cover is in contact with the bearing is a sealing device, and lubricating oil is prevented from entering the housing by the oil-impregnated wick.

8. The excited-vibration disc-cutting rock-breaking device of the front eccentric block according to claim 4, wherein the cutter disc (1) self-rotates at a rotating speed different from that of the main shaft (25), and rotating speeds of inner and outer rings of the first bearing (10) and the second bearing (19) are different.

9. The excited-vibration disc-cutting rock-breaking device of the front eccentric block according to claim 5, wherein the eccentric device (13) is installed at the front end of the main shaft and inside the cutter barrel, and generates vibration through rotation of an eccentric mass block.

10. The excited-vibration disc-cutting rock-breaking device of the front eccentric block according to claim 7, wherein the third bearing (23) and the fourth bearing (24) are installed on the main shaft in pairs and fixed by the round nut (21) and the stop washer (22), outer rings of the third bearing and the fourth bearing are fixed, and inner rings of the third bearing and the fourth bearing rotates with the main shaft.

11. The excited-vibration disc-cutting rock-breaking device of the front eccentric block according to claim 7, wherein the front end of the housing (7) is sealed by the housing sealing end cover (6) and the oil-impregnated wick (14), and the oil-impregnated wick (14) is installed on the main shaft (25).

12. The excited-vibration disc-cutting rock-breaking device of the front eccentric block according to claim 7, wherein the driving component is arranged inside the supporting component, the motor (17) is installed in the wrist (8), a rear end of the wrist (8) is connected to the lug (4), a structure of the lug (4) is for reference only, and a specific structure depends on an installation method of the cutting arm of the road-header.

13. The excited-vibration disc-cutting rock-breaking device of the front eccentric block according to claim 7, wherein the supporting component is fixedly connected to the cutting arm of the road-header.

14. An excited-vibration disc-cutting rock-breaking device of a front eccentric block, comprising:
a main body of a road-header;
a cutting arm of the road-header, which is arranged at a front part of the main body of the road-header; and
a rock-breaking device according to claim 1, which is arranged at a front end of the cutting arm of the road-header.

15. The excited-vibration disc-cutting rock-breaking device of a front eccentric block according to claim 14, wherein the cutting component comprises a cutter disc (1), a split semi-circular cutter barrel (2), a cutter head sealing end cover (9), a first bearing (10), a cutter head front-end fixing device (11), a second bearing (19), a cutter head rear-end fixing device (20), and a cutter barrel sealing end cover (3); the cutter disc (1) is detachably installed at a front end of the split semi-circular cutter barrel (2) and is fixed by the cutter head front-end fixing device (11); the first bearing (10) is installed at a front-most end of the main shaft (25) and is fixed by the cutter head sealing end cover (9) and a collar (12), an outer ring of the first bearing is connected to the cutter head front-end fixing device (11); the second bearing (19) is installed at the front end of the main shaft (25) and is fixed by an eccentric device (13) and a shaft shoulder, an outer ring of the second bearing is connected to the cutter head rear-end fixing device (20); the split semi-circular cutter barrel (2) is installed on the cutter head front-end fixing device (11) and the cutter head rear-end fixing device (20), and is sealed by the cutter barrel sealing end cover (3); and the cutting component rotates freely through friction with a rock to ensure that a cutter head and the main shaft (25) rotate around a central axis (5) at different rotating speeds through the first bearing and the second bearing installed on the main shaft (25).

16. The excited-vibration disc-cutting rock-breaking device of a front eccentric block according to claim 15, wherein the eccentric excitation device comprises an eccentric device (13), a collar (12), and a spline (18); a detachable mass block is installed on the eccentric device (13), different mass blocks are replaced according to actual working conditions, and a structure on the eccentric device (13) and an installation method of the mass block are not described in detail here; and the eccentric device (13) is installed at a position of the spline (18) at the front end of the main shaft (25), and is fixed by the collar (12) and the second bearing (19) to ensure that the main shaft (25) drives the eccentric device (13) to rotate around the central axis (5) to generate vibration.

17. The excited-vibration disc-cutting rock-breaking device of a front eccentric block according to claim 15, wherein the split semi-circular cutter barrel (2) and the main shaft (25) are fixedly connected through the first bearing (10), the cutter head front-end fixing device (11), the second bearing (19), and the cutter head rear-end fixing device (20); the split semi-circular cutter barrels (2) are two identical parts, which are installed at an outermost side of the cutter barrel, and the cutter disc (1) is installed on the split semi-circular cutter barrel (2); a space is reserved in the cutter barrel for installing the eccentric excitation device; and through the first bearing (10) and the second bearing (19), the cutting component freely rotates through friction with a rock.

18. The excited-vibration disc-cutting rock-breaking device of a front eccentric block according to claim 16, wherein the eccentric device (13) is installed at the front end of the main shaft (25) through a spline, located between the first bearing (10) and the second bearing (19), and close to the cutter disc (1), and when the main shaft (25) drives the eccentric device (13) to rotate, vibration generated by rotation of the eccentric device (13) is effectively transmitted to the cutter disc (1), and rock cutting efficiency is improved.

19. The excited-vibration disc-cutting rock-breaking device of a front eccentric block according to claim 14, wherein the driving component comprises the main shaft (25), a connector (15), a coupling (16), and a motor (17); and in the driving component, the motor (17) is connected to the main shaft through the coupling (16) and the connector (15), and the motor (17) is fixedly installed on a wrist to provide power to rotate the main shaft (25).

20. The excited-vibration disc-cutting rock-breaking device of a front eccentric block according to claim 14, wherein the supporting component comprises a housing sealing end cover (6), an oil-impregnated wick (14), a housing (7), a wrist (8), a lug (4), a third bearing (23), a fourth bearing (24), a round nut (21), and a stop washer (22), the lug (4) is connected to a rear-end cutting arm, the housing (7) is installed outside the third bearing (23) and the fourth bearing (24) and connected to the wrist (8), the third bearing (23) and the fourth bearing (24) are both fixed by the round nut (21) and the stop washer (22), the housing sealing end cover (6) is installed at a front end of the housing (7), a part in which the housing sealing end cover is in contact with the bearing is a sealing device, and lubricating oil is prevented from entering the housing by the oil-impregnated wick.
